(19) United States
(12) Patent Application Publication
(10) Pub. No.: US 2014/0212352 A1
(43) Pub. Date: Jul. 31, 2014

(54) INTEGRATED PROCESS FOR CONVERSION OF STC-CONTAINING AND OCS-CONTAINING SIDESTREAMS INTO HYDROGEN-CONTAINING CHLOROSILANES

(71) Applicants: Yuecel Önal, Carl Junction, MO (US); Guido Stochniol, Haltern am See (DE); Ingo Pauli, Schmitten (DE); Norbert Schladerbeck, Kelkheim (DE)

(72) Inventors: Yuecel Önal, Carl Junction, MO (US); Guido Stochniol, Haltern am See (DE); Ingo Pauli, Schmitten (DE); Norbert Schladerbeck, Kelkheim (DE)

(73) Assignee: EVONIK DEGUSSA GmbH, Essen (DE)

(21) Appl. No.: 14/005,360

(22) PCT Filed: Jan. 27, 2012
(86) PCT No.: PCT/EP2012/051353

§ 371 Date: Mar. 6, 2014

(30) Foreign Application Priority Data
Mar. 16, 2011 (DE) 10 2011 005 647.5

(51) Int. Cl. C01B 33/107; C07F 7/08; C01B 33/029

(52) U.S. Cl. CPC C01B 33/10742; C01B 33/029; C01B 33/10757; C07F 7/0818
USPC 423/342; 423/349; 585/250; 422/187; 556/474

(57) ABSTRACT

The invention relates to a process for producing a product gas mixture containing hydrogen-containing chlorosilanes within an integrated process by hydrogenating integrated process by-product silicon tetrachloride and organochlorosilane, more particularly methyltrichlorosilane, with hydrogen in a pressurized hydrogenation reactor comprising one or more reaction spaces each consisting of a reactor tube of gastight ceramic material, wherein the product gas mixture is worked up and at least a portion of at least one product of the product gas mixture is used as starting material for the hydrogenation or as starting material for some other process within the integrated process. The invention further relates to an integrated system useful for practising the integrated process.

The invention relates to a process for producing a product gas mixture containing hydrogen-containing chlorosilanes within an integrated process by hydrogenating integrated process by-product silicon tetrachloride (STC) and organochlorosilane (OCS), more particularly methyltrichlorosilane, with hydrogen in a pressurized hydrogenation reactor comprising one or more reaction spaces each consisting of a reactor tube of gastight ceramic material, wherein the product gas mixture is worked up and at least a portion of at least one product of the product gas mixture is used as starting material for the hydrogenation or some other process within the integrated process. The invention further relates to an integrated system useful for practising the integrated process.

Hydrogen-containing chlorosilanes and more particularly trichlorsilane (TCS) are important raw materials for the production of the hyperpure silicon needed in the semiconductor and photovoltaics industry. The demand for TCS has risen continuously in recent years and will continue to rise for the foreseeable future.

Hyperpure silicon is produced from TCS by chemical vapour deposition (CVD) by the industrially standard Siemens process. The TCS used is typically obtained by a chlorosilane process, i.e. reaction of technical grade silicon with HCl (hydrochlorination of Si) at temperatures around 300° C. in a fluidized bed reactor, or at temperatures around 1000° C. in a fixed bed reactor and subsequent distillative work-up of the product mixture.

Depending on the choice of process parameters, both the CVD process of hyperpure silicon production and the chlorosilane process can by-produce major quantities of silicon tetrachloride (STC). Besides STC, these processes further by-produce minor amounts of organochlorosilanes (OCS), more particularly methyldichlorosilane (MHDCS) and methyltrichlorosilane (MTCS), through reaction of organic impurities with chlorosilanes. Organochlorosilanes are further produced specifically by Müller-Rochow synthesis from silicon and alkyl chlorides. The production of dimethyldichlorosilane as the most important starting material for silicone production from silicon and chloromethane generates significant amounts of MTCS as co-product.

In view of the rising demand for TCS and hyperpure silicon, it would be economically very attractive to exploit these sidestreams of STC and organochlorosilanes, more particularly the MTCS sidestreams of a Müller-Rochow process, for the semiconductor and photovoltaics industry.

Various processes have accordingly been developed for converting STC into TCS. The standard industrial approach is to use a thermally controlled process for hydrodehalogenation of STC to TCS, wherein the STC is passed together with hydrogen into a graphite-lined reactor and reacted at temperatures of 1100° C. or higher. The high temperature and the presence of hydrogen cause the equilibrium to shift in the direction of the TCS product. After the reaction, the product gas mixture is discharged from the reactor and separated off in costly and inconvenient processes.

Process improvements suggested here in recent years include more particularly, as elaborated in U.S. Pat. No. 5,906,799 for example, the use of carbon-based materials with a chemically inert coating, of SiC say, for lining the reactor. In this way, degradation of the construction material and contamination of the product gas mixture due to reactions of the carbon-based material with the chlorosilane/H₂ gas mixture can be largely avoided.

DE 102005046703 A1 describes the in situ SiC coating of a graphitic heating element in a step preceding hydrodehalogenation. Disposing the heating element in the interior of the reaction chamber increases the efficiency of energy input from the electric resistance heating.

Yet the above processes are disadvantageous in that costly and inconvenient coating processes are required in some instances. Moreover, the heat needed for the reaction to proceed has to be supplied by electrical resistance heating because of the use of carbon-based construction materials, which is uneconomical compared with direct heating using natural gas. In addition, the required high reaction temperatures of typically 1000° C. or higher give rise to undesired deposits of silicon, which necessitate regular cleaning of the reactor.

The essential disadvantage, however, is the fact that the reaction is carried out purely thermally, without a catalyst, making the above processes altogether very inefficient. Accordingly, various processes have been developed for catalytic hydrodehalogenation of STC.

A commonly assigned earlier application describes a process for hydrodehalogenation of SiCl₄ to TCS. In this process, the reaction advantageously takes place under superatmospheric pressure and in the presence of a catalyst comprising at least one active component selected from the metals Ti, Zr, Hf, Ni, Pd, Pt, Mo, W, Nb, Ta, Ba, Sr, Ca, Mg, Ru, Rh, Ir or combinations thereof or silicide compounds thereof. This method provides high space-time yields of TCS with a virtually thermodynamic degree of conversion and high selectivity. The reactor used in the process contains one or more reactor tubes consisting of gastight ceramic material and preferably coated with the catalyst. More particularly, reactor tubes consisting of SiC, Si₃N₄ or hybrid systems thereof are used which are sufficiently inert, corrosion-resistant and gastight even at the high required reaction temperatures around 900° C. Owing to this choice of material, the heat for the reaction is supplied economically by disposing the reactor tubes in a combustion chamber heated by burning natural gas.

This reactor system has also been used for hydrogenating MTCS to form a chlorosilane mixture comprising dichlorosilane (DCS), TCS and STC under process conditions typically required for hydrodechlorination of STC to TCS, and provides a high space-time yield and selectivity for TCS. Further by-products formed include methane, HCl and MHDCS. However, significant conversions with regard to MTCS are only obtained at a temperature of 800° C. or higher. These high temperatures have an unwanted secondary effect in leading to an unfavourable level of deposition of solids consisting essentially of silicon. However, it has been found that combining the hydrogenation of MTCS with the hydrodehalogenation of STC significantly reduces solids deposits in the reactor during operation and, what is more, increases the yield of TCS. Advantageous ways to interconnect and operate reactors suitable for this form part of the subject matter of a parallel application. The process described utilized MTCS and STC as commercially obtained pure substances. For a large scale industrial process, by contrast, the supply with inexpensive raw materials is preferable. Therefore, economic use in an integrated process of the silicon tetrachloride and/or methyltrichlorosilane by-produced in a CVD process of hyperpure silicon production, in the hydrochlorination of silicon and/or a Müller-Rochow synthesis would be desirable.

The problem addressed by the present invention was therefore that of providing an integrated process which can be used on a large industrial scale for producing hydrogen-containing chlorosilanes by using these silicon tetrachloride-containing sidestreams and methyltrichlorosilane-containing sidestreams efficiently and as economically as possible.

To solve this problem, it was found that STC-containing sidestreams of a CVD process of hyperpure silicon production and/or of a process for hydrochlorination of Si and MTCS-containing sidestreams, particularly of a Müller-Rochow synthesis, can be reacted with hydrogen in a hydrogenation reactor integrated into the integrated process to form hydrogen-containing chlorosilanes and, after separation of the product gas mixture, the individual product streams can be sent to an economic further use preferably in the integrated process. More particularly, the process provides an increased yield of commercially useful intermediate and end products, especially TCS and the hyperpure silicon for semiconductor and photovoltaic applications which is obtainable therefrom.

The basis for the present invention is the abovementioned reactor concept of a parallel commonly assigned application concerning a process for combined hydrogenation of MTCS and hydrodehalogenation of STC to hydrogen-containing chlorosilanes in a pressurized reactor system comprising catalytically coated reactor tubes consisting of gastight ceramic material. This reactor concept makes it possible, given a suitable choice of reactor circuitry and of reaction parameters such as temperature, pressure, residence time and amount of substance ratios for the starting materials, to provide an efficient process for hydrogenation of MTCS and hydrodehalogenation of STC to hydrogen-containing chlorosilanes at high space-time yield and selectivity with regard to TCS. The option of an economical heat input by disposing the gastight ceramic reactor tubes as reactor spaces in a heating chamber fired with combustible gas by-produced in the integrated process constitutes a further advantage of the process.

The solution provided by the present invention to the abovementioned problem including preferred embodiments will now be described.

The invention provides a process for producing a product gas mixture containing at least one hydrogen-containing chlorosilane within an integrated process by hydrogenating at least the starting materials silicon tetrachloride and methyltrichlorosilane with hydrogen in a hydrogenation reactor comprising one or more reaction spaces, wherein the process additionally comprises a work-up of the product gas mixture by separating off at least a portion of at least one product and the use of at least a portion of at least one of the optionally multiple separated-off products as starting material for the hydrogenation or as starting material for at least one other process within the integrated process, characterized in that the hydrogenation reactor is operated under superatmospheric pressure and the one or more reaction spaces each consist of a reactor tube of gastight ceramic material. The terms “hydrogenation” and “hydrogenation reactor” are to be understood in the context of the present invention as meaning a hydrodehalogenation reaction such as, for instance, the reaction of STC with hydrogen to form hydrogen-containing chlorosilanes and/or a hydrogenation reaction such as, for instance, the reaction of MTCS with hydrogen to form hydrogen-containing chlorosilanes and, respectively, a reactor for practising these reactions.

The at least one other process in the integrated process of the present invention comprises at least one process selected from the group comprising a process for hydrochlorination of silicon, a process for deposition of silicon from the gas phase and a process for practising a Müller-Rochow synthesis.

A “hydrochlorination of silicon” is to be understood in the context of the present invention as meaning a process in which silicon is reacted with HCl under heat input to form chlorosilanes. A “deposition of silicon from the gas phase” relates in the context of the present invention to a process wherein elemental silicon is deposited by decomposition reaction of a gaseous Si-containing compound. Furthermore, a “Müller-Rochow synthesis” in the context of the present invention is a process for production of alkylhalosilanes by catalytic reaction of at least one alkyl halide, preferably methyl chloride, with silicon.

The aforementioned other processes can generate STC-containing and/or OCS-/MTCS-containing sidestreams.

Sidestreams comprising silicon tetrachloride can be more particularly generated therein in the course of the hydrochlorination of technical grade silicon to produce TCS. The technical grade silicon used therein is of low purity and is typically obtained by reduction of quartz sand with coke in an electric arc oven. The hydrochlorination can be carried out according to prior art methods, for example in a reactor similar to a fixed bed or in a fluidized bed reactor with silicon as fixed or fluidized bed, in which case the temperature setting varies with the reactor type between 300° C. (fluidized bed reactor) and about 1000° C. (fixed bed reactor). The hydrochlorination is advantageously carried out in a fluidized bed process in order that the yield with regard to TCS may be increased. The hydrochlorination further by-produces hydrogen, which can be separated off by subsequent condensation and, for example, fed as starting material to the pressurized hydrogenation reactor in the integrated process. Separating the product mixture of chlorosilanes which is obtained from the hydrochlorination to isolate high-purity TCS in particular can be done by distillation.

Significant amounts of silicon tetrachloride, on the other hand, can also be by-produced in the deposition of silicon from the gas phase, more particularly in the deposition of high-purity silicon from TCS in a CVD process in line with Siemens technology. In this process, high-purity TCS is typically reduced with hydrogen at temperatures around 1100° C. Polycrystalline high-purity silicon builds up from the gas phase on thin rods of silicon. These rods of silicon when fully grown can be used to produce silicon single crystals for the semiconductor and photovoltaics industry via the zone melting process or the Czochralski process for example. STC generated in the course of the CVD deposition of silicon can be separated off by working up the gaseous product mixture via condensation and subsequent distillation for example. Further by-produced HCl can be used for hydrochlorination of silicon.

MTCS is by-produced in major quantities particularly in the Müller-Rochow synthesis for production of dimethyldichlorosilane as most important raw material for the production of silicones. Technical grade silicon is typically reacted here with methyl chloride in the presence of copper-based catalysts at temperatures of 280 to 320° C. in moving bed or fluidized bed reactors. In addition to the main product, dimethyldichlorosilane, it is particularly MTCS, trimethylchlorosilane and also MHDCS which are formed. The various chlorosilanes can be isolated by distillative work-up of the product mixture. Minor sidestreams comprising MTCS are also generated in the course of the hydrochlorination of silicon, since organic impurities react with chlorosilanes to preferentially form organochlorine compounds, more particularly MHDCS as well as MTCS.

The STC- and/or MTCS-containing product mixtures from the hydrochlorination of silicon, the deposition of silicon from the gas phase and/or from a Müller-Rochow synthesis can thus be worked up using prior art methods such as condensation, distillation and/or absorption for instance, so that STC and MTCS are present in the STC-containing sidestreams and in the MTCS-containing sidestreams, respectively, in very pure form and/or as mixtures.

All versions of the integrated process which are in accordance with the present invention have the common feature that at least a portion of the STC and/or MTCS used as starting material for the hydrogenation is by-produced in at least one of the aforementioned other processes.

The other processes preferably comprise a process for hydrochlorination of silicon and/or a process for deposition of silicon from the gas phase which each generate STC-containing sidestreams and a process for practising a Müller-Rochow synthesis which generates MTCS-containing sidestreams.

The STC-containing sidestreams and the MTCS-containing sidestreams in the process of the present invention can each be collected in a reservoir and fed from there to the hydrogenation reactor in the integrated process under metered addition of hydrogen.

In all process variants according to the present invention, the methyltrichlorosilane as methyltrichlorosilane-containing feed gas and/or the silicon tetrachloride as silicon tetrachloride-containing feed gas and/or the hydrogen as hydrogen-containing feed gas can be fed as pressurized streams into one or more reaction spaces of the hydrogenation reactor and reacted therein, by supply of heat, to form at least one product gas mixture comprising at least one hydrogen-containing chlorosilane.

The gastight ceramic material of which the reactor tubes of the hydrogenation reactor consist is preferably selected from SiC or Si₃N₄, or hybrid systems (SiCN) thereof, and optionally at least one reactor tube is packed with packing elements made of the same material. Particular preference is given to using pressureless sintered SiC(SSiC), silicon-infiltrated SiC (SiSiC) or so-called nitrogen-bonded SiC (NSiC). These are pressure stable even at high temperatures, so that the reaction of STC and MTCS with hydrogen can be run at several bar of pressure. They are further sufficiently corrosion-resistant even at the necessary reaction temperatures of above 800° C. In a further embodiment, the materials of construction mentioned may have a thin coating of SiO₂ in the μm range as an additional corrosion control layer.

In a particularly preferred embodiment of the process according to the present invention, the inside walls of at least one reactor tube and/or at least some of the packing elements have a coating with at least one material catalyzing the reaction of MTCS and STC with H₂ to form hydrogen-containing chlorosilanes. In general, the tubes can be used with or without catalyst, although the catalytically coated tubes constitute a preferred embodiment since suitable catalysts lead to an increased rate of reaction and thus to an increased space-time yield. When the packing elements are given a catalytically active coating, it may be possible to dispense with the catalytically active internal coating in the reactor tubes. However, even in this case it is preferable for the inside walls of the reactor tubes to be included in the coating, since this enlarges the catalytically useful surface area compared with purely supported catalyst systems (in the form of a fixed bed for example).

When the inside walls of the reactor tubes and/or an optionally used fixed bed have a coating of a catalyzing material, the catalyzing material preferably consists of a composition comprising at least one active component selected from the metals Ti, Zr, Hf, Ni, Pd, Pt, Mo, W, Nb, Ta, Ba, Sr, Ca, Mg, Ru, Rh, Ir or combinations thereof or silicide compounds thereof, insofar as these exist. In addition to the at least one active component, the composition frequently contains in addition one or more suspension media and/or one or more auxiliary components, particularly for stabilizing the suspension, for improving the storage stability of the suspension, for improving the adherence of the suspension to the surface to be coated and/or for improving the application of the suspension to the surface to be coated. Application of the catalytically active coating to the inside walls of the reactor tubes and/or to the optionally used fixed bed can be effected by applying the suspension to the inside walls of the one or more reactor tubes and/or to the surface of the packing elements, drying the applied suspension and subsequent heat treatment at a temperature in the range from 500° C. to 1500° C. under inert gas or hydrogen.

The at least one reaction tube is typically disposed in a heating chamber. The heat needed to conduct the reaction can be introduced by burning a fuel gas, more particularly natural gas generated within the integrated process, in the heating chamber. In order that a uniform temperature profile may be achieved and local temperature spikes in the reactor tubes may be avoided when heating with a fuel gas, the burners should not point directly at the tubes. For instance, they can be distributed throughout the heating chamber and directed such that they point into the free space between parallel reactor tubes.

To enhance energy efficiency, the hydrogenation reactor can further be connected to a heat recovery system. In one particular embodiment, one or more reactor tubes are sealed at one end for this purpose and each contain a gas-feeding interior tube which preferably consists of the same material as the reactor tubes. Flow reversal occurs here between the sealed end of a particular reactor tube and the interiorly lying tube's opening facing this sealed end. In this arrangement, the ceramic interior tube in each case transfers heat from product gas mixture flowing between reactor tube inside wall and interior tube outside wall to reactants streaming in through the interior tube. The integrated heat-exchange tube may also have an at least partial coating with the catalytically active material described above.

The unwelcome deposition of Si-based solids, which typically takes place in the reaction of organochlorosilanes such as MTCS with H₂ at reaction temperatures above 800° C., is advantageously significantly reducible through suitable combination with the hydrodehalogenation of STC with hydrogen while operating the hydrogenation reactor. A suitable combination is possible, for example, with the various hereinbelow described modes of reactor operation. Without wishing to be tied to any one particular theory, the inventors believe that the HCl formed in all these variants by the hydrodehalogenation of STC with hydrogen favours the hydrochlorination reaction of the silicon in the solid deposits to form chlorosilanes and particularly hydrogen-containing chlorosilanes. This further removes HCl from the thermodynamic equilibrium of the hydrodehalogenation of STC, so that the resulting shift in equilibrium also serves to increase the yield of hydrogen-containing chlorosilanes and particularly of TCS.

In one specific embodiment of the process according to the present invention, at least one and optionally every reaction space is alternatingly supplied with a) the organochlorosilane/methyltrichlorosilane and b) the silicon tetrachloride, each in admixture with the hydrogen for hydrogenation. In this case, the hydrogenation of STC on the one hand and of MTCS on the other preferably takes place simultaneously in separate reaction spaces.

The molar ratio used here is advantageously in the range from 50:1 to 1:1 and preferably in the range from 20:1 to 2:1 for STC:MTCS (or OCS), and in the range from 1:1 to 8:1 and preferably in the range from 2:1 to 6:1 for STC:H₂ and in the range from 1:1 to 8:1 and preferably in the range from 2:1 to 6:1 for MTCS (or OCS): H₂.

Switching between the feed of STC on the one hand and MTCS/OCS on the other, each in admixture with the hydrogen, to the individual reaction spaces can be done simultaneously for all reaction spaces or independently of each other. The times for switching can be more particularly determined as a function of pressure and/or mass balance changes measured in at least one reaction space. These parameters can be suitable for indicating the formation of a significant amount of solid deposits or, conversely, the substantial removal of solid deposits formed in the reactor. Solid deposits in a reaction space can reduce the flow cross-section thereof and thus cause a pressure drop. Pressure can be measured according to any method known in the prior art, for example using suitable mechanical, capacitative, inductive or piezoresistive pressure meters. Substantial removal of Si-based solid deposits in a reaction space can be evident for example from an increased HCl concentration in the product gas mixture leaving this reaction space, since the consumption of HCl by the hydrochlorination reaction with silicon is reduced by the decreasing availability of the latter. The composition of the product gas can be measured using known analytical techniques, for example gas chromatography combined with mass spectrometry.

The switches in feeding the starting materials to the individual reaction spaces in the manner described above can be effected using a suitable customary control valve system.

The molar ratio of H₂ to MTCS in feeding the starting materials to the reaction spaces in this mode of reactor operation is typically set in the range from 1:1 to 8:1 and preferably in the range from 2:1 to 6:1, while the molar ratio of H₂ to STC is typically set in the range from 1:1 to 8:1 and preferably in the range from 2:1 to 6:1.

In a preferred method of reactor operation according to the invention, the methyltrichlorosilane and the silicon tetrachloride are fed simultaneously to at least one conjoint reaction space in admixture with the hydrogen for hydrogenation, and the molar ratio of methyltrichlorosilane to silicon tetrachloride is set in the range from 1:50 to 1:1, the molar ratio of methyltrichlorosilane to hydrogen is set in the range from 1:1 to 8:1 and the molar ratio of silicon tetrachloride to hydrogen is set in the range from 1:1 to 8:1. In the simplest case, therefore, the reaction takes place in a single conjoint reaction space. Constant removal of the Si deposited in the reaction of MTCS by the HCl formed at the same time in the same reaction space in the course of hydrodehalogenation of STC serves to ensure sustained stable operation.

A further preferred method of reactor operation in the process of the present invention comprises feeding the silicon tetrachloride admixed with the hydrogen to at least one first reaction space and the methyltrichlorosilane, optionally admixed with the hydrogen, to at least one second reaction space for hydrogenation, and the product gas mixture leaving the at least one first reaction space is additionally fed to the at least one second reaction space. Silicon deposited as intermediate in the course of the hydrogenation of MTCS in the at least one second reaction space can subsequently be removed again by the HCl-containing product gas mixture from the at least one first reaction space to thereby sustain stable operation of the hydrogenation reactor.

With the reactor interconnection as above, the hydrogen needed for the reactions can also be fed to the reactor together with STC only, via the at least one first reaction space. The at least one second reaction space can then be fed with an MTCS stream to which the product gas mixture from the at least one first reaction space is added. Hydrogen in said product gas mixture as a result of being unconverted in the at least one first reaction space can then react with MTCS in the at least one second reaction space. It is preferable, however, for hydrogen to be fed to the reactor not only together with STC, feeding the at least one first reaction space, but also together with MTCS, feeding the at least one second reaction space. This allows a more independent setting of advantageous amount of substance ratios for the hydrodehalogenation of STC in the first reaction space and for the hydrogenation of MTCS in the second reaction space.

The molar ratio of H₂ to STC shall preferably be set in the range from 1:1 to 8:1 and more preferably in the range from 2:1 to 6:1 for the reaction in the at least one first reaction space. The molar ratio of hydrogen to MTCS is preferably set in the range from 1:1 to 8:1 and more preferably in the range from 2:1 to 6:1 for the reaction in the at least one second reaction space.

A feature common to all the variants of the process according to the present invention is that the hydrogenation in the hydrogenation reactor is typically carried out at a pressure of 1 to 10 bar, preferably of 3 to 8 bar and more preferably of 4 to 6 bar, at a temperature greater than 800° C. and preferably at a temperature in the range from 850° C. to 950° C. and with gas streams having a residence time in the range from 0.1 to 10 s and preferably in the range from 1 to 5 s.

The product gas mixture formed in the process of the present invention by the hydrogenation of STC and MTCS with H₂ typically comprises at least HCl and methane in addition to at least one hydrogen-containing chlorosilane. It may contain organochlorosilanes such as MTCS, MHDCS and dimethyldichlorosilane in addition to oligomeric and monomeric chlorosilanes, more particularly hydrogen-containing chlorosilanes, e.g. SiH₄, SiClH₃, SiCl₂H₂ (DCS), STC and TCS. Unconverted hydrogen can be present as volatile component in the product gas mixture in addition to HCl, CH₄. In the event of boron contamination, various chlorinated boron compounds may likewise be present in the product gas mixture. By way of components, the product gas mixture from the reaction of STC and MTCS with hydrogen in the hydrogenation reactor typically comprises at least three or all products from the group comprising HCl, methane, hydrogen, dichlorosilane, trichlorosilane, silicon tetrachloride, methyldichlorosilane and methyltrichlorosilane. Frequently, the product gas mixture further comprises high boilers.

The components present in the product gas mixture are then typically isolated in as pure a form as possible and subsequently sent to their further use, preferably within the integrated process.

The work-up of the product gas mixture can differ with the composition of the product gas mixture and has to meet the requirements of the particular operation and integrated process. Suitable embodiments and apparatuses of usable physico-chemical separation processes such as condensation, freezing, distillation absorption and/or adsorption are discernible for example from Ullmanns Enzyklopädie der technischen Chemie, 4th edition, Verlag Chemie GmbH, Weinheim, volume 2, pages 489 ff. Specific variants of embodification which are usable in the integrated process of the present invention are recited hereinbelow.

At least a portion of at least one product separated off by the work-up is used as starting material for hydrogenation or as starting material for some other process within the integrated process.

Starting materials left unconverted in the hydrogenation are advantageously recyclable into the hydrogenation reactor. Hydrogen obtained by working up the product gas mixture is thus typically at least partly used as starting material for the hydrogenation in the integrated process of the present invention. Similarly, silicon tetrachloride and/or methyltrichlorosilane obtained by working up the product gas mixture are typically at least partly used as starting materials for hydrogenation.

HCl obtained by working up the product gas mixture can at least partly be used as starting material in a process for hydrochlorination of silicon within the integrated process, provided a process for hydrochlorination of silicon is part of the integrated process. In this case, high boilers separated from the product gas mixture can also be at least partly used as starting materials for hydrochlorination of silicon within the integrated process. In addition, these can also be at least partly withdrawn from the integrated process as products for further use and/or for disposal.

Trichlorosilane obtained by working up the product gas mixture can be at least partly used as starting material in a process for deposition of silicon from the gas phase within the integrated process provided a process for deposition of silicon from the gas phase is part of the integrated process, and/or be at least partly withdrawn from the integrated process as product for further use. Therefore, the integrated process can provide for a significant enhancement in the yield of the economically useful product TCS, in which case the aforementioned further use of TCS in the integrated process is particularly preferable for production of hyperpure silicon for semiconductor and photovoltaics applications for example.

Dichlorosilane, which can optionally be obtained in admixture with TCS by working up the product gas mixture in the process of the present invention, is preferably at least partly withdrawn from the integrated process as a product for further use. For example, a functionalization with organic moieties can be carried out subsequently by hydrosilylation. Methyldichlorsilane obtained by working up the product gas mixture from the hydrogenation is normally also at least partly withdrawn from the integrated process as product for further use outside the integrated process, for example as reactant and/or additive in various descendent operations.

In addition, methane obtained by working up the product gas mixture is advantageously at least partly usable as fuel for heating the hydrogenation reactor. For this, the separated-off methane-containing gas is, in the integrated process of the present invention, fed to at least one burner pointing into the heating chamber in which the reaction spaces of the hydrogenation reactor are arranged, and burned by metered addition of air or oxygen.

The invention further provides an integrated system for practising a process for producing a product gas mixture containing at least one hydrogen-containing chlorosilane by working up the product gas mixture by separating off at least a portion of at least one product and using at least a portion of at least one of the optionally multiple separated-off products in the process, characterized in that the integrated system comprises:
a component plant for hydrochlorination of silicon and/or a component plant for deposition of silicon from the gas phase,
a component plant for practising a Müller-Rochow synthesis,
a hydrogenation reactor for hydrogenation of at least silicon tetrachloride and methyltrichlorosilane,
a component plant for working up a product gas mixture formed in the hydrogenation reactor,
and one or more of the following components:
a line for feeding methane obtained by the work-up of the product gas mixture to at least one burner for heating the hydrogenation reactor,
a line for feeding hydrogen obtained by the work-up of the product gas mixture to the hydrogenation reactor,
a line for feeding methyltrichlorosilane and/or silicon tetrachloride obtained by the work-up of the product gas mixture to the hydrogenation reactor,
a line for feeding HCl and/or high boilers obtained by the work-up of the product gas mixture to the component plant for hydrochlorination of silicon,
a line for feeding trichlorosilane obtained by the work-up of the product gas mixture to the component plant for deposition of silicon from the gas phase,
a line for withdrawing dichlorosilane and/or trichlorosilane obtained by the work-up of the product gas mixture,
a line for withdrawing methyldichlorosilane obtained by the work-up of the product gas mixture,
a line for withdrawing high boilers obtained by the work-up of the product gas mixture.

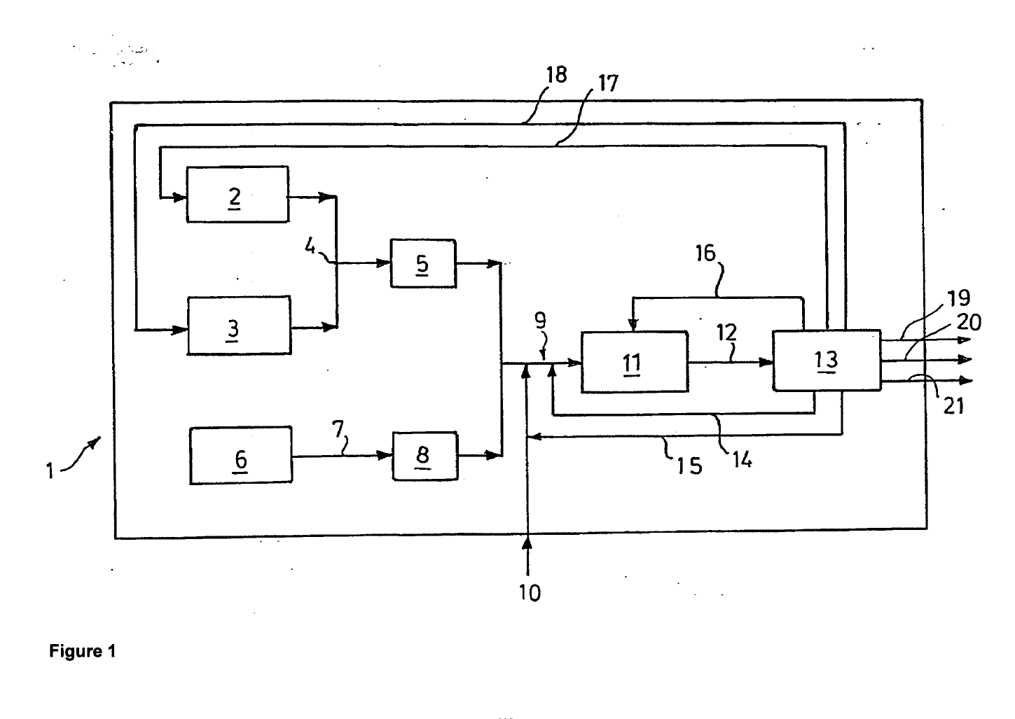

This integrated system, as depicted in FIG. 1 by way of example, is preferably used to practise the integrated process of the present invention. Operation of the component plant for hydrochlorination of silicon and/or the component plant for deposition of silicon from the gas phase typically generates silicon tetrachloride as a by-product, while operation of the component plant for practising a Müller-Rochow synthesis by-produces MTCS. These STC-containing sidestreams and MTCS-containing sidestreams can each be collected in a reservoir and sent from there to the hydrogenation reactor for reaction with co-fed hydrogen.

Working up the product gas mixture formed in the hydrogenation reactor can be done, as mentioned, according to prior art methods. Specific embodiments described hereinbelow are thus merely to be regarded as illustrative options and not as restrictive.

In one particular embodiment of the process according to the present invention, hydrogen is thus typically separated off in the work-up of the product gas mixture by at least the steps of:
cooling the product gas mixture,
contacting the uncondensed and H₂-containing fraction of the product gas mixture with an absorption medium,
contacting the unabsorbed fractions with an adsorption medium adsorbing organic compounds, and
withdrawing the unadsorbed hydrogen.

Similarly, methane can be separated off in the work-up of the product gas mixture by at least the steps of:
cooling the product gas mixture,
contacting the uncondensed and CH₄-containing fraction of the product gas mixture with an absorption medium,
contacting the unabsorbed fractions with an adsorption medium adsorbing CH₄, and
desorbing the adsorbed methane and withdrawal.

Cooling the product gas mixture from the hydrogenation, which originally contains at least two or more of the components H₂, HCl, CH₄, DCS, TCS, STC, MHDCS, MTCS and high boilers, to temperatures lower than ˜70° C. can be used to separate the volatile constituents therein from the condensing constituents.

The absorption medium with which the uncondensed fraction of the product gas mixture is subsequently contacted preferably comprises at least one chlorosilane. The contacting with the absorption medium can be effected by passing the gas mixture over a moving bed. Chlorosilanes and HCl in the gas mixture can thus be removed by absorption.

The gas stream leaving the absorption unit then contains H₂, CH₄ and other off-gases and can subsequently be passed over a suitable adsorption medium for adsorptive separation. Activated carbon in particular is useful as adsorption medium. Methane and other off-gases are adsorbed by the activated carbon, while hydrogen is not adsorbed by this adsorption medium and is thus obtainable in purified form from the contact with activated carbon. Following at least partial saturation of the adsorption medium with CH₄ and other off-gases, by contrast, the adsorbates can be liberated in gaseous form by desorption and subsequently sent to their further use. Desorption can be effected for example thermally by heating the adsorption medium. The CH₄-containing off-gas stream is preferably sent to a burner for energy and heat production.

The condensate from cooling the original product gas mixture from the hydrogenation to temperatures lower than −70° C., which contains one or more of the components HCl, DCS, TCS, STC, MHDCS, MTCS and high boilers, is typically subjected to a subsequent distillative work-up for separation. When an absorption medium comprising at least one chlorosilane is used for contacting the uncondensed fraction of the product gas mixture, it is preferably combined with the condensate after the absorption step for distillative work-up.

HCl can be separated off in the work-up of the product gas mixture for example by at least the steps of:
cooling the product gas mixture,
pressure distillation of the condensate, optionally combined with the absorption medium after contact thereof with the uncondensed fraction of the product gas mixture, and
withdrawing the HCl via the top of the pressure distillation column.

Si-based compounds and high boilers, by contrast, are typically separated off in the work-up of the product gas mixture by at least the steps of:
cooling the product gas mixture,
pressure distillation of the condensate, optionally combined with an absorption medium after contact thereof with the uncondensed fraction of the product gas mixture, and
multi-stage distillation of the distillation residue of the pressure distillation.

High boilers may be separated off as residue of the first distillation stage.

In a preferred embodiment of the present invention, the multi-stage distillation of the distillation residue of the pressure distillation may comprise four or more distillation stages. In this case, a mixture comprising silicon tetrachloride and methyltrichlorosilane may be separated off as residue of the second distillation column and a mixture comprising dichlorosilane and trichlorosilane may be separated off via the top of the third distillation column. Furthermore, a mixture comprising methyldichlorosilane can thus be separated off as residue of the fourth distillation column. More particularly, however, trichlorosilane can thus be separated off via the top of the fourth distillation column. Trichlorosilane separated in this way from the product mixture of the hydrogenation reactor can be used without further work-up for deposition of silicon from the gas phase in the integrated process of the present invention.

The component plant for working up the product gas mixture formed in the hydrogenation reactor may comprise one or more of the following components:
a unit for cooling the product gas mixture transferred out of the hydrogenation reactor down to a temperature <−70° C.,
a unit for contacting the uncondensed fraction of the product gas mixture with an absorption medium, preferably an absorption medium comprising at least one chlorsilane,
a unit for contacting the unabsorbed fractions of the product gas mixture with an adsorption medium, preferably activated carbon,
a unit for pressure distillation of the condensate,
a unit for multi-stage distillation of the residue of the pressure distillation.

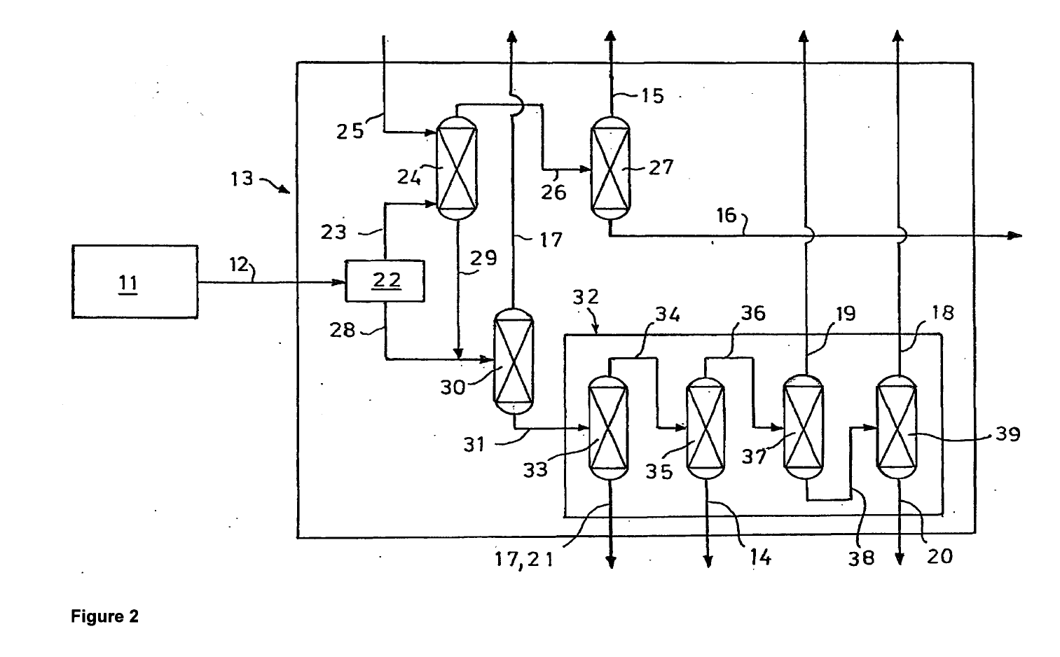

A specific and suitable embodiment of the component plant for working up the product gas mixture which includes all the aforementioned components and in which the multi-stage distillation of the residue of the pressure distillation is carried out as described in four serially connected distillation columns, is illustrated in FIG. 2 by way of example.

FIG. 1 is an illustrative schematic of an integrated system according to the present invention.

FIG. 2 is an illustrative schematic of a possible variant of a component plant for working up the product gas mixture obtained according to the present invention after hydrogenation of STC and MTCS with hydrogen in the hydrogenation reactor.

Returning to FIG. 1, the depicted integrated system 1 comprises a component plant 2 for hydrochlorination of silicon and a component plant 3 for deposition of silicon from the gas phase, the operation of which gives rise to silicon tetrachloride-containing sidestreams, which are fed through a line 4 to a reservoir 5 for collection. The integrated system further comprises a component plant 6 for practising a Müller-Rochow synthesis, the operation of which gives rise to methyltrichlorosilane-containing sidestreams, which are fed through a line 7 into a reservoir 8 for collection therein. The STC-containing and MTCS-containing sidestreams are fed from their reservoirs through one or optionally more than one line 9 under metered addition of hydrogen through one or optionally more than one further line 10 to the hydrogenation reactor 11 for hydrogenation. The resulting product gas mixture is transferred through a line 12 from the hydrogenation reactor to a component plant 13 for working up the product gas mixture, where separation of the product gas mixture takes place. Lines 14,15 feed respectively STC and MTCS on the one hand and H₂ on the other separated off by the work-up of the product gas mixture to the hydrogenation reactor for renewed use as starting materials. Methane-containing off-gas from the work-up of the product gas mixture can be fed through a line 16 to at least one burner for heating the hydrogenation reactor. Separated-off HCl and also a portion of isolated high boilers are fed through a line 17 into the component plant 2 for hydrochlorination of silicon as starting materials, while the essential portion of the trichlorosilane obtained by working up the product gas mixture from the hydrogenation is fed through another line 18 to component plant 3 for deposition of silicon from the gas phase as a starting material. Further lines 19,20,21 can further be used to withdraw from the integrated system 1 DCS/TCS mixture, methyldichlorosilane-containing mixture and high boilers, respectively, each separated off by working up the product gas mixture, for further use outside the integrated process.

Turning now to FIG. 2, the depicted component plant 13 for working up the product gas mixture comprises a cooling unit 22, in which the product gas mixture supplied from the hydrogenation reactor 11 through a line 12 is cooled down to condense the non-volatile constituents. The uncondensed constituents of the product gas mixture are fed through a line 23 to an absorption unit 24 and are contacted there with an absorption medium, comprising at least one chlorosilane, supplied through another line 25. A further line 26 feeds the fractions of the gas mixture which are not absorbed by the absorption medium to a downstream adsorption unit 27 for contact therein with activated carbon as adsorption medium. The methane-containing adsorbate, after at least partial saturation of the activated carbon, can be desorbed and conducted away through a corresponding line 16 from the component plant for working up the product gas mixture 13, while hydrogen is not adsorbed by the activated carbon and can be withdrawn directly from the outlet of the adsorption unit 27 through another line 15. The condensate withdrawn from the cooling unit 22 is fed through a line 28 under admixture with the absorption medium comprising at least one chlorosilane from the absorption unit after contact thereof with the uncondensed constituents of the product gas mixture to a pressure distillation unit 30 via a further line 29. HCl can be taken off at the top of the pressure distillation column and fed via a connected line 17 to a further use. The residue from the pressure distillation, by contrast, is transferred by a further line 31 to a downstream unit for multi-stage distillation 32, where the residue here is fed to a first distillation column 33. A line 17, 21 is used to withdraw the distillation residue of the first distillation column 33, which contains high boilers. The overhead stream of the first distillation column 33, by contrast, is passed through a line 34 into a second distillation column 35. The second distillation column 35 can have withdrawn from it, through a further line 14, an STC- and MTCS-containing mixture as distillation residue. The overhead stream of the second distillation column 35 is in turn transferred 36 to a third distillation column 37 connected in series. The overhead stream of this third distillation column 37, containing a mixture of DCS and TCS, is conducted away through a further line 19 for further use, while the distillation residue is transferred via another line 38 to a fourth distillation column 39. The distillation residue of this fourth distillation column 39, an MHDCS-containing mixture, is then conducted away through a corresponding line 20, while TCS can be withdrawn at the top of the fourth distillation column 39 and fed through another line 18 to its further use.

### LIST OF REFERENCE SYMBOLS

(1) integrated system
(2) component plant for hydrochlorination of silicon
(3) component plant for deposition of silicon from the gas phase
(4) line for STC-containing sidestreams
(5) reservoir for STC-containing sidestreams
(6) component plant for practising a Müller-Rochow synthesis
(7) line for MTCS-containing sidestreams
(8) reservoir for MTCS-containing sidestreams
(9) feed line(s) to hydrogenation reactor
(10) line(s) for H₂
(11) hydrogenation reactor
(12) line for product gas mixture from hydrogenation
(13) component plant for working up the product gas mixture
(14) line(s) for STC and/or MTCS separated from the product gas mixture
(15) line for H₂ separated from the product gas mixture
(16) line for CH₄ separated from the product gas mixture
(17) line(s) for high boilers or/and HCl separated from the product gas mixture
(18) line for TCS separated from the product gas mixture
(19) line(s) for DCS and/or TCS separated from the product gas mixture
(20) line for MHDCS separated from the product gas mixture
(21) line for high boilers separated from the product gas mixture
(22) cooling unit
(23) line for uncondensed constituents of product gas mixture
(24) absorption unit
(25) feed line for absorption medium
(26) line for gas mixture fractions not absorbed by absorption medium
(27) adsorption unit
(28) line for condensed constituents of product gas mixture
(29) line for absorption medium after contact with uncondensed constituents of product gas mixture
(30) pressure distillation unit
(31) line for transferring the residue of the pressure distillation
(32) unit for multi-stage distillation
(33) first distillation column
(34) line for transferring the overhead stream of the first distillation column
(35) second distillation column
(36) line for transferring the overhead stream of the second distillation column
(37) third distillation column
(38) line for transferring the residue of the third distillation column
(39) fourth distillation column

1. An integrated process for producing a gas mixture, comprising:
hydrogenating at least silicon tetrachloride and methyltrichlorosilane with hydrogen in a hydrogenation reactor comprising one or more reaction spaces, thereby obtaining the gas mixture,
working-up the gas mixture by separating off at least a portion of at least one product, and
introducing at least a portion of at least one of optionally multiple separated-off products as starting materials into the hydrogenation reactor or as starting materials for at least one other process within the integrated process,
wherein:
the gas mixture comprises a hydrogen-comprising chlorosilane,
the hydrogenation reactor is operated under superatmospheric pressure, and
the one or more reaction spaces each consist of a reactor tube of gastight ceramic material.

2. The process according to claim 1,
wherein
the product gas mixture further comprises HCl and methane.

3. The process according to claim 1,
wherein
the gas mixture comprises at least three products selected from the group consisting of HCl, methane, hydrogen, dichlorosilane, trichlorosilane, silicon tetrachloride, methyldichlorosilane and methyltrichlorosilane.

4. The process according to claim 3,
wherein
the at least one other process within the integrated process comprises at least one process selected from the group consisting of a process for hydrochlorination of silicon, a process for deposition of silicon from a gas phase, and a process for a Müller-Rochow synthesis.

5. The process according to claim 4,
wherein
at least a portion of silicon tetrachloride, methyltrichlorosilane, or both used as starting materials in the hydrogenation reactor are by-products in the at least one other process.

6. The process according to claim 1,
wherein
HCl obtained by said working up is at least partly used as a starting material in a process for hydrochlorination of silicon within the integrated process.

7. The process according to claim 1,
wherein
silicon tetrachloride, methyltrichlorosilane, or both obtained by said working up are at least partly used as starting materials in the hydrogenation reactor.

8. The process according to claim 1,
wherein
hydrogen obtained by said working up is at least partly used as a starting material in the hydrogenation reactor.

9. The process according to claim 1,
wherein
methane obtained by said working up is at least partly used as fuel for heating the hydrogenation reactor.

10. The process according to claim 1,
wherein
trichlorosilane obtained by said working up is at least partly used as a starting material in a process for deposition of silicon from a gas phase within the integrated process, or at least partly withdrawn from the integrated process as a product for further use, or both.

11. The process according to claim 1,
wherein
high boilers obtained by said working up are at least partly used as starting materials in a process for hydrochlorination of silicon within the integrated process or withdrawn from the integrated process at least partly as products for further use, or both.

12. The process according to claim 1,
wherein
dichlorosilane obtained by said working up is at least partly withdrawn from the integrated process as a product for further use.

13. The process according to claim 1,
wherein
methyldichlorosilane obtained by said working up is at least partly withdrawn from the integrated process as product for further use.

14. The process according to claim 1,
wherein a process for separating hydrogen in said working up comprising:
cooling the gas mixture,
contacting an uncondensed and H₂-comprising fraction of the gas mixture with an absorption medium,
contacting unabsorbed fractions with an adsorption medium adsorbing organic compounds, and
withdrawing unadsorbed hydrogen.

15. The process according to claim 1,
wherein a process for separating methane in said working up comprising:
cooling the gas mixture,
contacting an uncondensed and CH₄-comprising fraction of the product gas mixture with an absorption medium,
contacting unabsorbed fractions with an adsorption medium adsorbing CH₄, and
desorbing adsorbed methane and withdrawing methane.

16. The process according to claim 1,
wherein a process for separating HCl in said working up comprising:
cooling the gas mixture,
pressure distilling a condensate via a pressure distillation column, optionally combined with an absorption medium after contacting with an uncondensed fraction of the gas mixture, and
withdrawing HCl via a top of the pressure distillation column.

17. The process according to claim 1,
wherein a process for separating Si-comprising compounds and high boilers in said working up comprising:
cooling the product gas mixture,
pressure distilling a condensate, optionally combined with an absorption medium after contacting with an uncondensed fraction of the gas mixture, and
distilling, via multi-stage distillation, distillation residue obtained after said pressure distilling.

18. The process according to claim 17,
wherein
the high boilers are separated as residue of a first distillation stage of the multi-stage distillation.

19. The process according to claim 17,
wherein
the multi-stage distillation comprises four or more distillation stages.

20. An integrated system,
comprising:
component plant for hydrochlorination of silicon or a component plant for deposition of silicon from a gas phase or both,
a component plant for a Müller-Rochow synthesis,
a hydrogenation reactor for hydrogenation of at least silicon tetrachloride and methyltrichlorosilane,
a component plant for working up a gas mixture formed in the hydrogenation reactor,
and one or more lines selected from the group consisting of:
a line for feeding methane obtained by working up the gas mixture to at least one burner for heating the hydrogenation reactor,
a line for feeding hydrogen obtained working up the gas mixture to the hydrogenation reactor,
a line for feeding methyltrichlorosilane, silicon tetrachloride, or both, obtained by working up the gas mixture to the hydrogenation reactor,
a line for feeding HCl, high boilers, or both obtained by working up the gas mixture to the component plant for hydrochlorination of silicon,
a line for feeding trichlorosilane obtained by working up the gas mixture to the component plant for deposition of silicon from the gas phase,
a line for withdrawing dichlorosilane, trichlorosilane, or both, obtained by working up the gas mixture,
a line for withdrawing methyldichlorosilane obtained by working up the gas mixture, and
a line for withdrawing the high boilers obtained by working up the gas mixture,
wherein
the gas mixture comprises a hydrogen-comprising chlorosilane, and
the integrated system is suitable for a process for producing the gas mixture by working up the gas mixture by separating at least a portion of at least one product and using at least a portion of at least one of optionally multiple separated products in the process.

21. The integrated system according to claim 20,
wherein
the component plant for working up the gas mixture formed in the hydrogenation reactor comprises one or more units selected from the group consisting of:
a unit for cooling the gas mixture transferred out of the hydrogenation reactor down to a temperature of <−70° C.,
a unit for contacting an uncondensed fraction of the gas mixture with an absorption medium,
a unit for contacting unabsorbed fractions of the gas mixture with an adsorption medium,
a unit for pressure distillation of condensate, and
a unit for multi-stage distillation of residue of the pressure distillation.
